(19) United States
(12) Patent Application Publication
(10) Pub. No.: US 2025/0154741 A1
(43) Pub. Date: May 15, 2025

(54) SYSTEMS AND METHODS FOR FLOOD PREVENTION

(71) Applicant: GHW Solutions, LLC, Fort Worth, TX (US)

(72) Inventors: Stephen Graham, Houston, TX (US); Jonathon Weiss, Fort Worth, TX (US); Gerald Graham, Fort Worth, TX (US)

(73) Assignee: GHW Solutions, LLC, Fort Worth, TX (US)

(21) Appl. No.: 18/838,752

(22) PCT Filed: May 2, 2022
(86) PCT No.: PCT/US2022/027228

§ 371 Date: Aug. 15, 2024

Related U.S. Application Data
(60) Provisional application No. 63/310,209, filed on Feb. 15, 2022.

(51) Int. Cl. E02D 31/00; E06B 9/00

(52) U.S. Cl. CPC E02D 31/00; E06B 9/00; E06B 2009/007

(57) ABSTRACT

A comprehensive dry flood proofing solution to mitigate inland flooding risk for existing or new homes and small buildings. The integrated house wrap system of the present disclosure leverages the building's structure to offer practical and affordable flood protection for those buildings constructed with slab-on-grade foundations. The components of the solution are reusable, easy to deploy, and do not detract from the building's permanent appearance. Furthermore, the solution allows for ingress/egress during flood events and can protect the building from standing water incursion up to 24″ above slab elevation. The pre-flood design and preparation, the deployment immediately preceding flooding event and the subsequent removal after flooding event has passed is provided by both contractors and homeowners.

### RELATED APPLICATIONS

This Patent Cooperation Treaty (PCT) application claims priority to U.S. Provisional Application No. 63/310,209, filed Feb. 15, 2022, and is incorporated herein by reference. This application, PCT Application No. PCT/US19/31838, U.S. Pat. No. 11,060,313, and US Patent Application Publication No. US 2021/0310268 are commonly assigned to GHW Solutions, LLC.

### FIELD OF THE DISCLOSURE

The following disclosure generally relates to systems and methods for flood prevention. More particularly, the following disclosure relates to a removable, reusable dry flood proofing solution that is easy to deploy on short notice before a flood and economically leverages the structural support of the home.

### BACKGROUND

Many communities around the world are facing the challenges and devastation caused by flooding due to the increasing frequency of severe weather events, rising sea level, subsidence and urban sprawl. Most agree that massive infrastructure projects aimed at flood control will never eliminate regional flooding in densely developed areas. Cities cannot be redesigned to incorporate dedicated catch basins, sufficient in size, to collect and control stormwater runoff from flooding caused by heavy precipitation. There is little doubt that torrential rains will continue to result from hurricanes and other storm-related events. Structures in populated areas along the thousands of miles of U.S. coastline and inland areas proximate to the Atlantic and Gulf of Mexico will continue to be exposed to flooding caused by major precipitation events, storm surge and other contributory causes. However, flooding of this nature is not limited to our domestic areas; it is of worldwide concern.

Flooding from Hurricane Harvey in late August 2017, for example, caused widespread inland destruction in the greater Houston area. Flooding due to heavy rains from Harvey damaged more than 200,000 homes and businesses. Superstorm Sandy was another costly weather event in recent history that damaged or destroyed at least 650,000 homes in the northeast part of the U.S. Hurricane Katrina in 2005 was the most destructive natural disaster in U.S. history causing total damages of about $130 billion and flooding of more than a million homes in and around New Orleans. Climatologists and meteorologists are convinced heavy precipitation storms are becoming more frequent and getting stronger, and lasting longer. Coastal, riverine and surface flooding will continue to threaten millions of homes and other buildings located in low lying areas around the world which brings significant adverse consequences to building owners, lenders, insurance/re-insurance providers, federal/local governments and other stakeholders.

In response to major, catastrophic flooding, various flood barrier systems have been developed for different applications and/or structures. Many conventional flood barrier systems, however, require expensive, unsightly, permeant structures that surround the home or other building. Others are removable, but are not practical for deployment on short notice, fail to economically leverage the structural support of the home and/or are not reusable.

### BRIEF DESCRIPTION OF THE DRAWINGS

The present disclosure is described with reference to the accompanying drawings, in which like elements are referenced with like reference numbers, and in which:

FIG. 1 is a perspective view of a typical home with different types of exterior wall materials.

FIG. 2 is another perspective view of a typical home showing a garage and other features.

FIG. 3 is an elevation view of the home in FIG. 1 illustrating a house wrap system near an exterior door and a re-deployable protector assembly for the door.

FIG. 4 is a perspective view of the home in FIG. 3 illustrating semi-rigid plastic panels and other components used in the house wrap system to extend flood prevention along exterior walls.

FIG. 5 is a perspective view of the exhaust vent extension assembly in FIG. 4 used for protecting vents located below the DFE during a flood.

FIG. 6 is an elevation view of the home in FIG. 1 illustrating the house wrap system used to protect a low-lying bay window from flooding.

FIG. 7 is an elevation view of the home in FIG. 2 illustrating a system for sealing electrical and plumbing wall penetrations and a vertical edge of the house wrap system where it begins or ends along an exterior wall.

FIG. 8 is an elevation view of the home in FIG. 2 illustrating the house wrap system used to protect a sectional type garage door from flooding.

FIG. 9 is an elevation view of the home in FIG. 2 illustrating the house wrap system used to protect a non-sectional or solid type garage door from flooding.

FIG. 10 is an elevation view of a garage door support strut used in the house wrap system to reinforce a garage door against forces from flood waters.

FIG. 11 is a perspective view of the home in FIG. 1 illustrating an entryway protection assembly used in the house wrap system to protect fragile doors and windows from flooding.

FIG. 12 is a perspective view of the entryway protection assembly components in FIG. 11.

### DETAILED DESCRIPTION OF THE ILLUSTRATIVE EMBODIMENTS

The subject matter of the present disclosure is described with specificity, however, the description itself is not intended to limit the scope of the disclosure. The subject matter thus, might also be embodied in other ways, to include different structures, steps and/or combinations similar to and/or fewer than those described herein, in conjunction with other present or future technologies. Although the term “step” may be used herein to describe different elements of methods employed, the term should not be interpreted as implying any particular order among or between various steps herein disclosed unless otherwise expressly limited by the description to a particular order. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures and dimensions described herein are only exemplary and are not intended to assert or imply any limitation with regard to the environment, architecture, design, or process in which different embodiments may be implemented. For convenience, a list of components identified by the figures is provided in Table 1 below.

TABLE 1

| No. | Description | No. | Description | No. | Description |
|---|---|---|---|---|---|
| 1 | Existing Building | 2 | Ground Level | 3 | Design Flood |
| | | | Elevation (GLE) | | Elevation (DFE) |
| 4 | Concrete Foundation | 5a | Exterior Brick | 5b | Permeable Bricks |
| | | | Veneer Walls | | |
| 5c | Mortar Seams | 5d | Weep Holes | 5e | Cracks and Other |
| | | | | | Defects |
| 6a | Composite Sliding | 6b | Composite Siding | 7a | Recessed Windows |
| | Exterior Walls | | Planks | | |
| 7b | Recessed Window | 7c | Recessed Window | 8a | Bay Windows |
| | Frames | | Sills | | |
| 8b | Bay Window Frames | 9a | Exterior Entryway | 9b | Front Entryway |
| | and Sills | | | | Pedestrian Door |
| 9c | Entryway Door | 9d | Entryway Door | 9e | Entryway Windows |
| | Frame | | Threshold | | |
| 9f | Entryway Window | 9g | Entryway Window | 9h | Front Porch |
| | Glass | | Casings | | Substrate |
| 9i | Walkway Substrate | 9j | Transition Step | 10a | Additional Exterior |
| | | | | | Pedestrian Door |
| 10b | Door Frame and | 10c | Door Threshold | 10d | Patio Substrate |
| | Jambs | | | | |
| 11a | Sectional Garage | 11b | Non-sectional | 11c | Panels of Sectional |
| | Door | | Garage Door | | Garage Door |
| 11d | Frames of Garage | 11e | Bottom Edge of | 11f | Driveway Substrate |
| | Door | | Garage Door | | |
| 11g | Garage Floor | 12 | Exhaust Vent | 13 | Cable/Pipe Wall |
| | Substrate | | | | Penetrations |
| 14 | Other Wall | 15a | Semi-Rigid Plastic | 15b | ½″ D-shaped Closed- |
| | Appurtenances | | Panel | | cell Foam Gasket |
| 15c | Panel Edge Stiffener | 15d | ¾″ × ½″ Closed-cell | 16 | Wrap Deployment |
| | | | Foam Gasket | | Direction |
| 17 | 3/16″ Screw Fastener | 18 | Removable All | 19 | Removable All |
| | w/Washer | | Weather Gel Tape | | Weather Thin Tape |
| 20 | Flexible Sheeting | 21 | Expandable Door | 22a | Exhaust Vent |
| | Panel | | Protector | | Extension Assembly |
| 22b | Exhaust Vent | 22c | Snap-in Snorkel | 22d | Hooded Vent of |
| | Housing | | Riser for Housing | | Snorkel Riser |
| 22e | Receptacle Fitting of | 22f | O-Ring Seal at | 23 | Flexible Batting |
| | Housing | | Housing Fitting | | Panels |
| 24a | Wrap-around Cone | 24b | Water Proof Sealant | 25 | Flexible Weighting |
| | for Wall Penetrations | | | | Material |
| 26 | Weight Bag Mat | 27a | Garage Door Support | 27b | ¼″ Threaded |
| | | | Struts | | Masonry Anchors |
| 27c | Bolt Fasteners | 28a | Entryway Protectors | 28b | Square Tube Male |
| | | | | | Frame |
| 28c | Bottom of Female | 28d | Vertical Aluminum | 28e | Horizontal |
| | Square Frame | | Struts | | Aluminum Struts |
| 28f | Hex Bolts | 28g | Lattice Panels | | |

The present disclosure is directed toward a comprehensive dry flood proofing solution with integrated reusable components that are easy-to-deploy within a few hours immediately preceding a flood event. All potential leak points into a building to a design flood elevation (DFE) of up to approximately 24 inches from the top of a solid concrete foundation are addressed. The solution is suitable for existing homes, new homes and other building structures whereby the lowermost sections of the exterior walls are constructed using brick veneer, rock, stucco, wood/vinyl/composite siding, and/or other materials, which are sufficient to withstand the hydrostatic pressure caused by gently rising water up to the height of the DFE without structural failure. The suggested DFE height limitation of this disclosure is to mitigate possible damage to the foundation and other structural components of the building caused by buoyancy forces caused by rising flood waters on the outside of the house exceeding the weight of the structure and collapse forces related to the hydrostatic pressure applied against the exterior walls below the DFE.

The integrated dry flood proofing technology of the present disclosure also leverages the structural integrity of the building's concrete foundation and its exterior walls together with innovative solution components to enable cost effective protections, while allowing for ingress and egress during flood events. The solution includes a pre-flood design and preparation process (pre-flood prep), which should be completed in fair weather well in advance of any storms. The pre-flood prep process generally includes inspecting the home, designing the customized dry flood proofing solution, and preparing the landscape in close proximity to the building structure (e.g., trimming shrubbery), exposed concrete slab, and house exterior from ground level elevation (GLE) to the DFE (e.g., pressure washing) for application of the treatments and installation of solution components. In addition, certain building construction defects located below the DFE are addressed (e.g., cracks in exposed concrete foundation), certain exterior building surfaces are chemically treated with transparent sealants from GLE to the DFE, and deployable solution components are custom-fitted and labeled during the pre-flood prep process to facilitate emergency deployment by two or more physically capable adults during inclement weather. The comprehensive dry flood proofing system of the present disclosure leverages the exterior door and sewage anti-backflow protections described in U.S. Pat. No. 11,060,312 B2 issued on Jul. 12, 2021.

The systems and methods disclosed herein thus, overcome the prior art disadvantages associated with conventional flood barrier systems with a house wrap system that is reusable, easy to deploy by the home owner and/or building occupants on short notice and economically leverages the structural support of the home or building. The house wrap system disclosed herein also provides for long-term storage in a compact container, is durable and effective upon emergency deployment, is easy to remove after a flood threat passes, and will not detract from the appearance of the home before temporary deployment or after the system is removed. The benefits further extend to other stakeholders including, but not limited to, federal and local governments, insurance companies, mortgage lenders and home owner associations.

The house wrap system is a highly configurable, integrated solution for protecting exterior walls, doors, and windows to the DFE using pre-fitted, semi-rigid, high density polyethylene (HDPE) panels (or similar waterproof, semi-rigid, thin, plastic, flat sheet material), which are deployed immediately preceding a flood. The standard size of these semi-rigid plastic panels may be ˜ 1/32″ thick×24″ wide×8′ long, but they may be cut-to-fit using a suitable cutting device (e.g., circular saw with a carbide tipped blade). When joined together around the house, they are used to create a low-cost, impact resistant, and waterproof barrier between the exterior walls, windows, and doors and rising floodwater up to a DFE of nearly 24″ above the concrete slab. Their light weight (e.g., less than 4 lbs) and rigidity make them easy to install, even during windy conditions and when they must be placed behind landscape plants. Additionally, the panels may be easily removed after the flood threat passes and may be reused in multiple deployments year-after-year.

Other solution components of the house wrap system include removable all-weather thin tape, removable all-weather gel tape, flexible scrim-reinforced low density polyethylene (LDPE) sheeting (or similar waterproof, flexible, thin, plastic, rolled sheet material), flexible batting panels, support struts, entryway protectors, expandable door protectors, vent extension covers, panel edge stiffeners, weight bag mats, flexible weighting material, closed-cell foam gasket material, and fastening devices. The house wrap system is also uniquely designed to protect low-lying bay windows, garage door areas, and exterior walls.

The approximately 2″ wide, removable all-weather thin tape has a relatively thin coat (e.g., less than 5 mils) of aggressive adhesive (e.g., solvent acrylic-based) that instantly sticks to clean, non-porous, smooth surfaces (e.g., smooth hard plastic, flexible poly sheeting, glass, or painted metal surfaces) in both dry and water wet conditions. The primary application of the thin tape is temporarily joining and sealing multiple semi-rigid plastic panels along their vertical edges during emergency deployment of the house wrap system. During rainy weather, it may be helpful to wipe excess standing water off of the application surfaces using a dry or damp cloth before applying the 2″ wide thin tape in order to improve the instant bond characteristic. Also, a moderate amount of finger pressure applied against the backing of the 2″ wide thin tape during wet rainy weather applications should be used to squeeze excess water out from under the adhesive/plastic or adhesive/building surface, thereby improving its instant bond property. The single-sided, thin tape has a highly flexible, waterproof backing and may be easily cut-to-fit from bulk rolls using scissors or a knife. After a flood threat subsides, the thin tape may be easily removed from the semi-rigid plastic panels by applying a moderate amount of tensile force.

The approximately 4″ wide, removable all-weather gel tape is used to temporarily attach and seal the lower edge of the semi-rigid plastic panels to the exposed side edge of the building's concrete foundation near the top of the slab. This highly flexible gel tape is also used to anchor and seal the house wrap material along the vertical edges of its initiation and termination points, which by design are usually along painted wood trim on either side of the door designated for ingress/egress during the flood event. It has a relatively thick coat (e.g., greater than 10 mils) of aggressive adhesive gel (e.g., butyl rubber-based) instantly bonds to a variety of porous and non-porous exterior building surfaces in either wet or dry conditions. Moderate compression force applied via fingers to the flexible, waterproof backing of the 4″ wide gel tape should be used to squeeze excess water out from under the adhesive/building surface and for extrusion onto smooth or rugose exterior building surfaces.

The quick drying 4″ wide gel tape exhibits sufficient bond strength and waterproofing properties to withstand a flooding event to the DFE in less than two hours from initial application and may be completely removed from the exterior building surface and semi-rigid plastic panels by applying a moderate amount of tensile force with or without the application of a heat or cooling stream. Integral scrim fabric and/or fibrous material may be manufactured in the tape to further facilitate its complete removal. If any adhesive residue remains on the building surface during this removal process, it may be removed using a high pressure washer with water, solvent fluid, repeat press-on/pull-off process with a fresh piece of adhesive tape, and/or mechanical abrasion. To facilitate delivery and storage of the sticky 4″ wide gel tape product in bulk rolls, the adhesive gel may be covered using a protective release liner (e.g., non-stick wax paper) or a split protective release liner where a first liner is ½″ wide and a second liner is 3½″ wide. The gel tape having the split protective release liner can be used to pre-install the gel tape on the lower edge of certain semi-rigid plastic panels that will be deployed adjacent to exposed concrete slab.

The pre-flood prep process for the house wrap system may include applying transparent masonry/concrete sealant, clear paint sealers, and/or other specialty chemicals to the exterior of the house, exposed edges of the concrete slab, and concrete/tile flooring from GLE to the DFE in part to optimize the instant bond and removability properties of the removable all-weather tape products. This process also includes configuring a combination of standard size semi-rigid plastic panels (˜8′ long) and shorter panels that have been custom cut to fit specific features of an exterior wall, window, door, or other exterior appurtenance with a goal of substantially enclosing the exterior house structure from near GLE to the DFE using semi-rigid plastic panels, fasteners, and tape products during emergency deployment. For example, relatively small sections of panel material may be assembled using removable, all-weather thin tape to accommodate a bay window, which protrudes below the DFE. To address a low-lying exterior exhaust vent, a semi-rigid plastic panel may be modified by attaching and sealing a vent extension cover with snorkel riser over a small cutout (˜3″×3″) in the panel using the same tape product as another example. During this process, individual panels may be labeled to match their respective location along the exterior of the house to facilitate emergency deployment ahead of a possible flooding event by the home owner or occupant.

In a first design, each sized and labeled semi-rigid plastic panel may then be further configured during pre-flood prep by (a) pre-installing a strip of ˜½″ D-shaped closed-cell foam gasket to its upper edge using the pressure sensitive adhesive backing of the gasket material, (b) pre-drilling a 3/16″ hole near each of its upper corners overlying the foam gasket and at a location which optimizes the placement of Tapcon® or other screw anchors against the wall during emergency deployment (e.g., within a grout line for a masonry brick wall), and (c) pre-drilling a third 3/16″ hole at a location overlying the foam gasket and approximately midway between the first two holes if a panel is longer than about 6′. During panel deployment, Tapcon® or other screw fasteners may be installed through these pre-drilled holes and into the exterior wall at marked or measured locations to anchor the top edge of the semi-rigid plastic panels and create a water-resistant barrier during wind-driven rains via compression of the foam gasket. By design, the semi-rigid plastic panels may be positioned such that their vertical edges abut to the next adjacent panel or they may be arranged to overlap slightly (e.g., ˜2″) with the next panel against the exterior building surface. During emergency deployment, the nearly aligned vertical edge of two panels may be joined and sealed using 2″ wide thin tape while the lower edge may be sealed to the edge of the exposed concrete slab using 4″ wide gel tape in most cases.

In another design, pre-flood prep may include installing stainless steel or other corrosion-resistant brad nails in the exterior wall near the DFE to correspond with the exact location of the pre-drilled holes located in the upper corners of each panel (and midway between the first two holes for panels longer than about 6′) when the panels are installed. During emergency deployment, the panels may be hung on the brads using spring clips to secure the panels and to compress the foam gasket. As an alternative to installing the foam gasket, screw fasteners, and/or brad nails, a suitable all-weather, high tack, removable tape or other adhesive product may be used during emergency deployment to instantly anchor the upper edge of each the semi-rigid plastic panels to the exterior building surface at the DFE while creating a water-resistant barrier. For this optional design to work without mechanical fasteners, the high tack adhesive product must have sufficient immediate bonding strength to hold up the panel material against either a dry or wet surface and during high winds. Also, the product must be fully removable without damaging the exterior building surface after the flood threat passes.

To facilitate emergency deployment and dry floodproofing effectiveness, additional pre-flood prep work for the house wrap system may include:
Pre-installing 4″ wide gel tape along the lower edge of each semi-rigid plastic panel that may be directly anchored and sealed at their lower edge to exposed concrete slabs or concrete/tile flooring using ˜½″ of the tape material. The protective release liner covering the remaining ˜3½″ of the tape material may be left on the 4″ wide gel tape so it may be used to adhere to the slab or flooring during emergency deployment.
Using 2″ wide thin tape to pre-install a narrow section (˜4 to 6″ wide) of flexible poly-wrap sheeting panel to the lower edge of each semi-rigid plastic panel that may be deployed adjacent to exterior walls where there is lateral offset between the vertical plane of the wall and the exposed side of the concrete slab. This will effectively extend the semi-rigid plastic panel vertically with flexible waterproof material to facilitate anchoring and sealing the lower edge of the semi-rigid panel to the slab.
Pre-installing 4″ wide gel tape along the lower edge of a custom fitted flexible sheeting panel to be anchored and sealed at its lower edge to exposed concrete slabs using ˜½″ of the tape material. The protective release liner covering the remaining ˜3½″ of the tape material may be left on the 4″ wide gel tape so it may be used to adhere to the slab during emergency deployment.
Using 2″ wide thin tape to pre-install a narrow section (<12″ wide) of flexible poly-wrap sheeting panel to either the left or right vertical edge of each semi-rigid plastic panel that may be deployed adjacent to door frames where the house wrap will be initiated or terminated. The typical design of this house wrap system calls for initiating and terminating the house wrap at the door designated for ingress/egress, which will be protected using an expandable door protector during an impending flood event. The flexible poly-wrap sheeting panel will enable the complex corners of door frame to be covered in order to seal the house wrap at its initiation or termination location against the smooth painted or stained wood trim at the door frame using 4″ wide gel tape during emergency deployment. Custom sized flexible sheeting panels may also be used to extend semi-rigid plastic panels across areas of the exterior building structure where more flexibility is needed (e.g., where a fence or decking material abuts an exterior wall).
Pre-installing 4″ wide gel tape along the left or right vertical edge of a custom fitted flexible poly-wrap sheeting panel to be used for extending the vertical edge of semi-rigid plastic panels laterally to cover the complex corners of door frame trim material at house wrap initiation and termination points using ˜½″ of the tape material. The protective release liner covering the remaining ˜3½″ of the tape material will be left on the 4″ wide gel tape so it may be used to adhere to the wood trim surfaces of the door frame or other smooth painted or stained exterior building surfaces during emergency deployment.
For sectional type garage doors to be protected using the house wrap system, using 2″ wide thin tape to pre-install a narrow section (<20″ wide) of flexible poly-wrap sheeting panel along the upper edge of each semi-rigid plastic panel that may be deployed adjacent to a garage door. The flexible sheeting panels may extend the height of the semi-rigid panels vertically to enable securing the house wrap at its upper end during emergency deployment by first folding the upper edge of the flexible sheeting panel material a few times to create a narrow ridge (˜1″ wide) and then tucking the ridge into the closest articulated door panel joint, which is located above the DFE prior to completely closing the garage door. By design, the upper end of the house wrap will be at the proper height when the door is closed.
Pre-installing a weight bag mat, which is comprised of ˜12″ wide, ˜ 1/16″ thick, ˜30 durometer, closed-cell neoprene rubber or other suitable flexible waterproof material using 2″ wide thin tape to the lower edge of each semi-rigid plastic panel that may be deployed along exterior walls, windows, and/or doors where there is no exposed concrete foundation or concrete/tile flooring. This will allow weight bags or other heavy flexible material to be applied on top of the weight bag mat during emergency deployment to create an effective waterproof seal against the flooring or ground substrate.
Creating a detailed inventory of deployable components to facilitate re-stocking certain components that cannot be reused after initial deployment.

In one embodiment, the present disclosure includes a method for protecting a home or building with a slab-on-grade foundation from flood waters, which comprises: i) determining a size and number of waterproof, plastic panel(s) needed to protect an exterior area of the home or building from flooding between the foundation and a predetermined design flood elevation (DFE); ii) positioning each plastic panel, one at a time, against a respective section of the exterior area to be protected; iii) securing an upper edge of each plastic panel, one at a time, to an exterior surface of the home or building to form a top end horizontal water-resistant barrier; iv) securing a lower edge of each plastic panel, one at a time, to the foundation with a removable adhesive to form a bottom end horizontal waterproof seal; and v) securing each vertical side edge of each plastic panel, one at a time, to at least one of an exterior surface of the home or building, and a vertical side edge of an adjacent plastic panel with the removable adhesive to form a waterproof seal between each plastic panel and at least one of an exterior wall, a door, and a window.

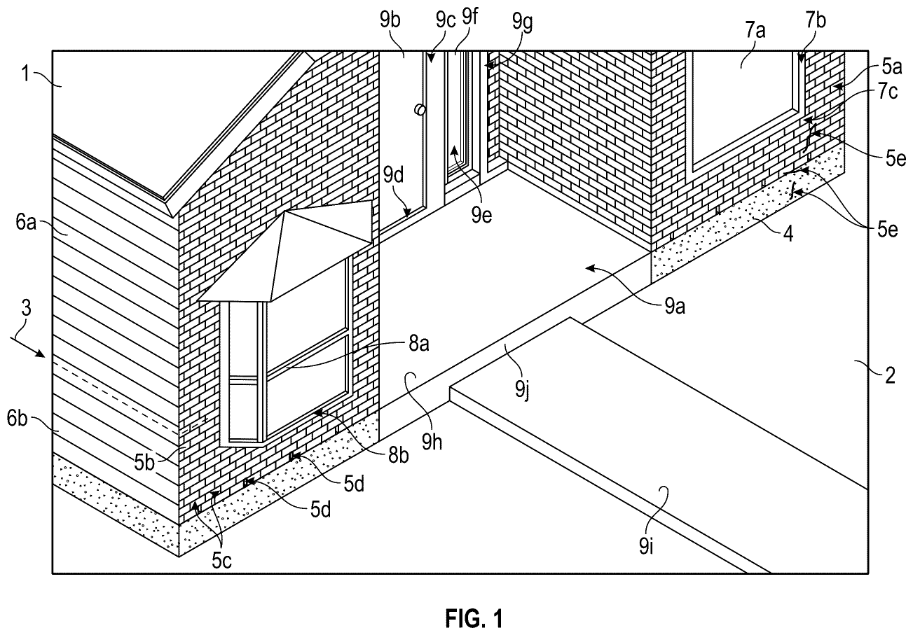

Referring now to FIG. 1, a perspective view illustrates an existing building 1 constructed using a combination of brick-veneer exterior walls 5a and composite siding exterior walls 6a over a solid concrete foundation 4, which includes recessed windows 7a, bay windows 8a, entryway windows 9e, a pedestrian door 9b at the front entryway 9a, front porch substrate 9h, walkway substrate 9i, a transition step from the walkway to the front porch 9j, mortar seams 5c in the brick-veneer walls 5a, and weep holes 5d formed by excluding the mortar from vertical seams along the first row of bricks of wall 5a adjacent to the top of the concrete foundation 4 at a spacing typically not greater than 33 inches. Potential water entry locations during a flooding event from GLE 2 to the DFE 3 of up to 24 inches above the top of concrete slab 4 include (a) weep holes 5d, (b) permeable bricks 5b of walls 5a, (c) cracks and other defects 5e in the concrete foundation 4 and masonry exterior wall 5a, (d) planks 6b of composite siding walls 6a, (e) frames, jambs, sills, and thresholds 9c, 9d of door 9b, and (f) frames, jambs, sills, and casings 7b, 7c, 8b, and 9g of windows 7a, 8a, and 9e.

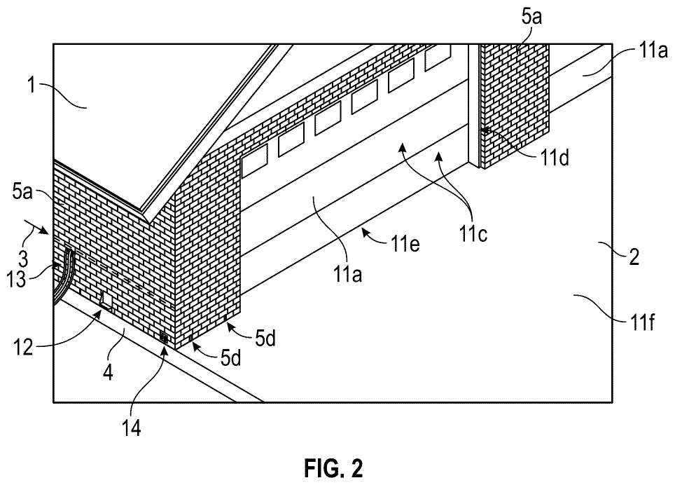

FIG. 2 illustrates another perspective view of building 1 highlighting additional potential leak points during a flooding event including (a) between the panels 11c of a sectional-type garage doors 11a, (b) along the bottom 11e of garage doors 11a adjacent to driveway 11f, (c) along the frames 11d of garage doors 11a, (d) exhaust vent 12, (e) electrical outlet 14, and (f) electrical, plumbing, and HVAC wall penetrations 13. In addition to potential leak points along the exterior of the house, flood waters can also cause sewage backup into toilets, shower, bathtub, and other drains located in the interior of the house on the ground floor. U.S. Pat. No. 11,060,312 B2 issued on Jul. 12, 2021 describes a Sewage Anti-Backflow System that effectively addresses flood threats related to sewage backup into the interior of the house on the ground floor.

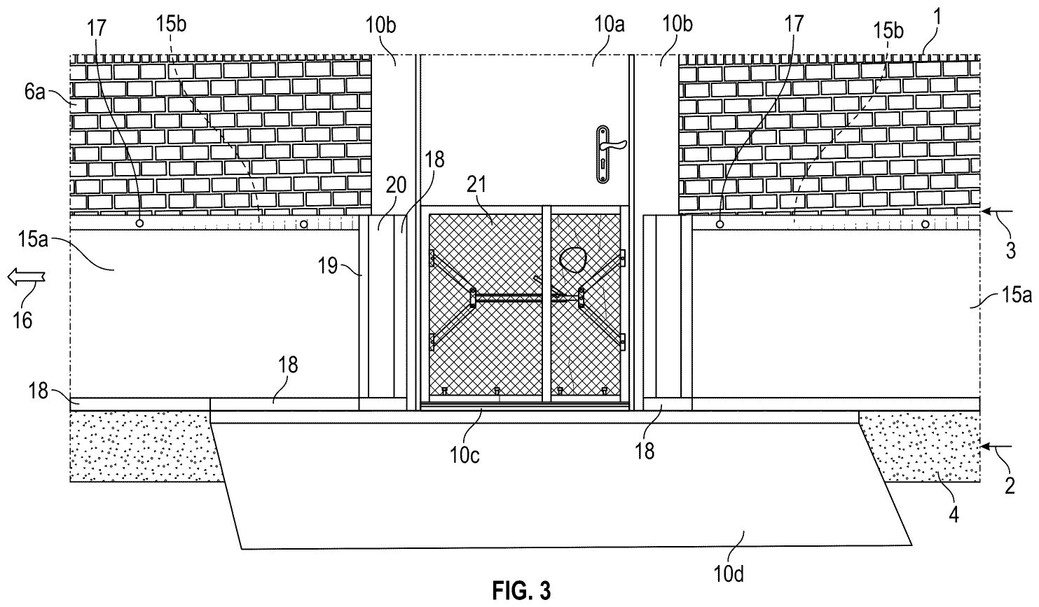

FIG. 3 illustrates the basic house wrap system in elevation view focused near the exterior door which is designated for ingress/egress during an impending flood event where the house wrap system is typically designed to initiate and terminate. During emergency deployment, one person will position the first semi-rigid plastic panel 15a per the location instructions annotated on the panel label. For the purpose of describing how the house wrap can be deployed, the installation of panels 15a will be assumed to move systematically around the house in a clockwise direction 16, although the process will work just as well if the installation process works in the opposite direction.

The right edge of the first semi-rigid panel 15a will usually be positioned parallel to and just a few inches to the left of the frame 10b of the door 10a which is designated for ingress/egress during the possible flood event. The vertical elevation of semi-rigid panel 15a may be adjusted such that its lower edge is just an inch or two below the top of the concrete foundation 4. After the first semi-rigid panel 15a, which weighs less than about 4 lbs, is held in the proper position, a second person will secure the top edge of semi-rigid panel 15a to exterior wall 6a constructed using wood, vinyl, hardie board, or other composite siding by driving a ˜ 3/16″ diam×1¼″ long hex head Tapcon® or other short self-tapping screw with a ˜ 3/16″×1½″ diam fender washer 17 through the two or three pre-drilled holes near the top edge of semi-rigid panel 15a and directly into the exterior wall 6a. If the exterior wall 6a is constructed using masonry (e.g., brick or rock veneer), then a 5/32″ hole may be drilled into the exterior wall 6a at the top left and top right corners of the semi-rigid panel 15a and ideally adjacent to a mortar joint before driving a short 3/16″ Tapcon® hex head screw with a 1½″ fender washer 17 to secure the top of the semi-rigid panel 15a to wall 6a. For semi-rigid panels 15a greater than 6′ in length, a third hole will be drilled at the top of the semi-rigid panel 15a midway between the two corner screws for an additional anchor point. Each screw will be tightened down only slightly to compress the ½″ wide D-shaped closed-cell foam gasket 15b to form a water-resistant barrier at the top edge of semi-rigid panel 15a against the wall 6a. It is important to note that the top seal of semi-rigid panel 15a does not have to be waterproof, but only resistant to water penetration during rainy conditions.

If a suitable all-weather, high tack, removable adhesive caulk or tape becomes available (e.g., removable, all-weather version of Loctite® Power Grab Ultimate Click & Stick or T-REX® Mounting Tape), using screws/washers 17 to secure the top edge of semi-rigid panels 15a may not be necessary. In this case, a few dabs of adhesive caulk or pieces of tape spaced out along the upper edge may be used to support semi-rigid panel 15a against the wall, window, or door. As an alternative to using pre-installed gasket 15b underlying the upper horizontal edge of semi-rigid panel 15a, 4″ wide gel tape 18 or 2″ wide thin tape 19 may be used for sealing the upper edge either with or without first installing stainless steel brads in the exterior wall 6a during pre-flood prep at the location corresponding to the pre-drilled holes in the upper corners of each semi-rigid panel 15a so they may be hung on the brads with spring clips before using 4″ wide gel tape 18 or 2″ thin tape 19 to create a water-resistant barrier.

After securing semi-rigid panel 15a at its top edge using screw anchors or adhesive, the remaining 3½″ of 4″ wide gel tape 18 that was pre-installed at the bottom edge of the semi-rigid panel 15a during preflood prep will be used to seal the bottom of semi-rigid panel 15a to the side of the concrete foundation 4 and/or the porch or patio flooring substrate 9h by systematically removing the protective liner covering the sticky gel side of the gel tape 18 and then firmly applying finger pressure to the backing of gel tape 18. 4″ wide gel tape 18 is designed to instantly adhere to clean concrete surfaces in either dry or wet conditions. Alternatively, the lower edge of semi-rigid panel 15a may be anchored and sealed using a combination of weight bag mats and weight bags or other heavy flexible material (not shown).

After securing the first semi-rigid panel 15a at its lower edge, the remaining 3½″ of 4″ wide gel tape 18 that was pre-installed along the right edge of the flexible poly-wrap sheeting panel 20 during preflood prep will be used to anchor and seal the right vertical of semi-rigid panel 15a to the painted or stained surfaces of the door frame trim 10b. As previously described, flexible sheeting panel 20 was also pre-installed along the right edge of first semi-rigid panel 15a using 2″ wide thin tape 19 during pre-flood prep.

In a similar manner, a flexible sheeting panel 20 is also used to extend the last semi-rigid panel 15a located at the termination point of the house wrap system immediately to the right side of the pedestrian door 10a such that it may be sealed onto the painted or stained door frame trim 10b located on the right side of the door 10a using the protected 3½″ of adhesive gel of the 4″ wide gel tape 18. During pre-flood prep, flexible sheeting panel 20 was pre-attached to the left vertical edge of the last semi-rigid panel 15a using 2″ wide thin tape 19 and 4″ wide gel tape 18 was pre-attached to left edge of flexible sheeting panel 20 as previous described. After installing additional semi-rigid plastic panels 15a between the first and last semi-rigid panel 15a one at a time and at the specific location on the house per its predefined labeling instruction, an expandable door protector 21 as described in U.S. Pat. No. 11,060,312 B2 issued on Jul. 12, 2021, may deployed immediately preceding a flood event to effectively seal and protect the exterior door 10a and part of door frame 10b from standing water levels up to the DFE 3. For inward-opening doors, deployed expandable door protector 21 does not prevent the door 10a from being opened in the presence of flood waters to facilitate home ingress and egress during the flooding event.

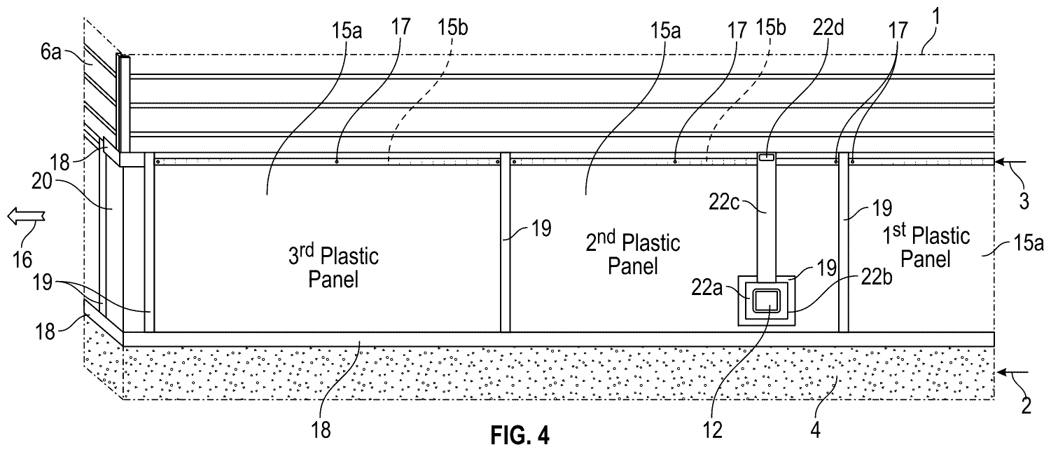

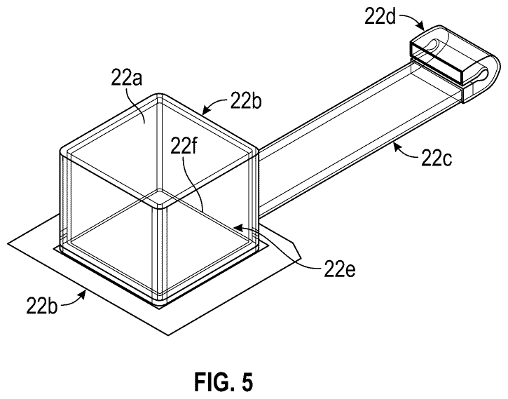

FIGS. 4-5 illustrates perspective views of the process of combining multiple semi-rigid plastic panels 15a with other components of the house wrap system used to protect exterior walls from flooding and the exhaust vent extension assembly 22a. The second semi-rigid panel 15a will be typically located immediately to the left of the first semi-rigid panel 15a (e.g., vertical edges are touching or nearly touching each other) per the deployment instructions on the panel label which is consistent with the strategy of systematically installing the house wrap system in a clockwise fashion 16 starting with the first semi-rigid panel 15a being located immediately to the left of the exterior door designated for ingress/egress during a possible flood event. Alternatively, multiple panels 15a may be positioned against the exterior wall 6a such that there is a small amount of lateral overlap between two semi-rigid panels 15a (e.g., ˜2″).

Exhaust vent extension assembly 22a is used for sealing and protecting a low lying exhaust vent 12 located along exterior walls 6a while maintaining an air exhaust vent at the DFE 3. Dome-shaped exhaust vent housing 22b is sized to completely encase exhaust vent 12 protruding from the exterior wall 6a below the DFE 3. During pre-flood prep, the lightweight plastic exhaust vent housing 22b is installed over a cutout in the second semi-rigid panel 15a using 2″ wide thin tape 19 applied to a ˜1″ wide flange of vent housing 22b and the second semi-rigid panel 15a. The cutout is formed in second semi-rigid plastic panel 15a using a rotary cutting tool or other suitable device and is located to accommodate the protruding exhaust vent 12 during emergency deployment.

A snap-in snorkel riser 22c with a removable hooded vent 22d is installed in the receptacle fitting 22e fitted with an O-ring seal 22f at the top of exhaust vent housing 22b during emergency deployment. After deployment, the tube of snorkel riser 22c communicates the hooded vent 22d at the top of snorkel riser 22c located approximately at the DFE 3 with the convex housing 22b on its lower end. The top of riser 22c may be cut shorter during pre-flood prep to accommodate the specific DFE requirement. The hooded vent 22d is designed to slide over the top of the snorkel riser 22c to provide a leak point into the building 1 to mitigate risk of wall collapse should flood water rise above DFE 3. The hood 22d at the top of the snorkel riser 22c is also designed to prevent rain from entering into snorkel riser 22c and housing 22b while allowing the exhaust vent 12 to continue working after the house wrap system is deployed. The length of snorkel 22b is designed to ensure the hooded vent at the upper end of snorkel 22b is located near the DFE 3.

During emergency deployment, the second semi-rigid panel 15a with the pre-installed exhaust vent extension assembly 22a, foam gasket 15b, and 4″ wide gel tape 18 along its bottom edge is positioned immediately to the left of the first semi-rigid panel 15a and the top and bottom edges of this second semi-rigid panel 15a are anchored and sealed using the previously described process in FIG. 3. Then, the vertically-oriented left edge of the first semi-rigid panel 15a is joined with the right edge of the second semi-rigid panel 15a and sealed using 2″ wide thin tape 19. Additional semi-rigid plastic panels 15a are installed onto the exterior of the house in clockwise fashion using a similar process.

FIG. 4 also shows the length of the first and second semi-rigid plastic panels 15a are standard size (e.g., ˜8′ long). However, the third semi-rigid panel 15a has been cut shorter during pre-flood prep to terminate the third semi-rigid panel 15a near the end of the exterior wall 6a. Also, the third semi-rigid panel 15a has been extended by a few inches by attaching a short section of flexible sheeting panel 20 to its left vertical edge using 2″ wide thin tape 19 during pre-flood prep. By design, the flexible sheeting panel 20 will be located adjacent to a corner of the house 1 where two exterior walls 6a meet during house wrap system deployment. The flexible sheeting panel 20 facilitates transitioning the stiffer semi-rigid panels 15a around corners of house 1 or other complex corners such as at door frames. A short piece of 4″ wide gel tape 18 may be used to seal the upper horizontal edge of flexible sheeting panel 20 to complete the transition of the house wrap system from one exterior wall to another wall 6a.

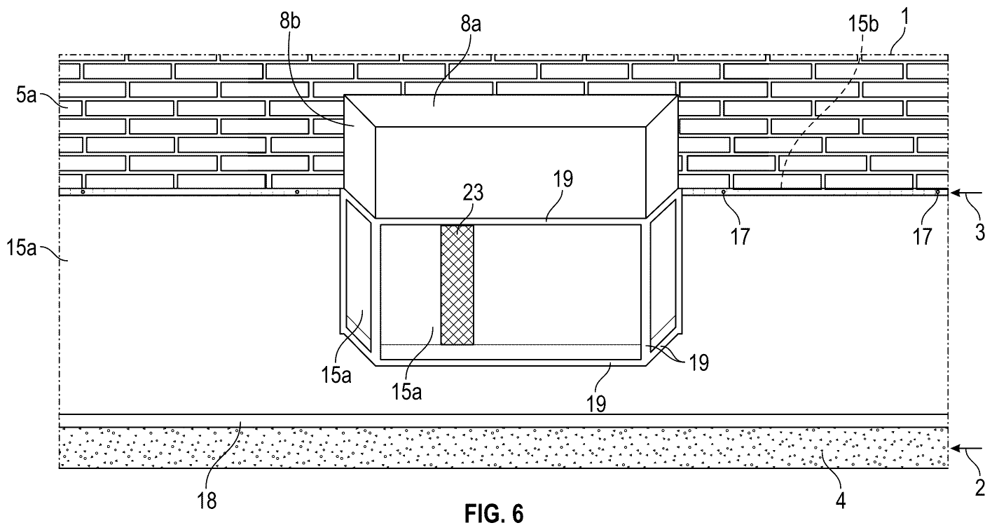

FIG. 6 illustrates an elevation view of the application of the house wrap system to protect a bay window 8a, which extends below the DFE 3. During pre-flood prep, smaller sections of semi-rigid panels 15a are cut into multiple pieces and then joined together using 2″ wide thin tape 19 to form a single waterproof semi-rigid panel 15a fitted to the profile of bay window 8a or another protruding area along exterior wall 5a and located below the DFE 4. Fragile glass in each bay window 8a is protected from floating debris during flooding by placing flexible batting panels 23 between the semi-rigid panels 15a and the glass during deployment. Flexible batting panels 23 are made from fabric or other flexible material and may also be cut-to-fit from their standard size of approximately 2″ thick by 35″ wide by 24″ tall. Flexible batting panels 23 will have been previously custom-fitted to the area to be protected and labeled during pre-flood prep to facilitate deployment.

The emergency deployment process for custom configured semi-rigid panels 15a covering bay window 8a is generally the same as the process described for semi-rigid panel 15a deployment in FIG. 4 (i.e., using 4″ wide gel tape 18 to anchor and seal the lower edge of semi-rigid panel 15a against the exposed side of concrete slab 4 and screws/washer mechanical fasteners 17 for securing the top edge of panel adjacent to exterior wall 5a). However, 2″ wide thin tape 19, which may be applied in both dry and wet conditions, may be used to create a water-resistant seal at top of the semi-rigid panel 15a against the glass and frame of window 8a at the DFE 3 because it is easier to remove from smooth glass surfaces after the flooding threat passes than the 4″ wide gel tape 18.

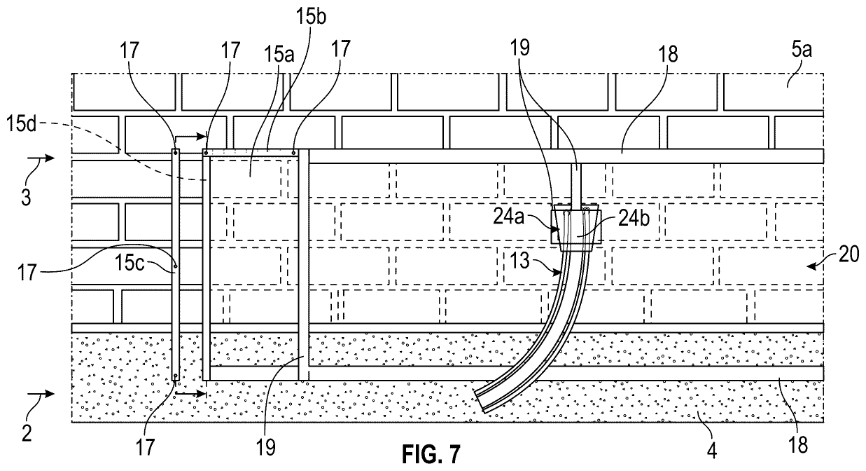

FIG. 7 illustrates an elevation view of a method for sealing electrical and plumbing appurtenance wall penetrations 13 with a wall penetration located below the DFE 3. During pre-flood prep, plastic wrap-around cone 24a is installed by wrapping the cone 24a around cable/pipe appurtenances 13 immediately adjacent to exterior wall 5a when cable/pipe appurtenances 13 penetrate wall 5a. UV-protected spray-on foam water proof sealant 24b, which is capable of adhering to the rough surface of cone 24a and the surface of wall 5a, is then applied to completely fill cone 24a to create an effective waterproof seal around cable/pipe appurtenances 13 at the penetration with wall 5a.

During emergency deployment, a short section of ˜24″ wide flexible sheeting panel 20 will be routed up from GLE 2 and behind any shrubbery and cable/pipe appurtenances 13 located in close proximity to wall 5a. To enable the upper horizontal edge flexible sheeting panel 20 to reach the DFE 3 while the lower horizontal edge is near the top of the concrete slab 4, a vertically-oriented slit is made in the flexible sheeting panel 20 using scissors or a knife down from the top to the location of the plastic wrap-around cone 24a which was used to encase the cable/pipe appurtenances 13 in foam sealant 24b during pre-flood prep. A circular cutout may be made to accommodate the size of cone 24a adjacent to wall 5a. The slit and circular cutout are then sealed using 2″ wide thin tape 19 to seal flexible sheeting panel 20 around cone 24a and cable/pipe appurtenances 13. The upper edge of flexible sheeting panel 20 is then anchored horizontally along wall 5a at the DFE 3 using 4″ wide gel tape 18. The bottom edge of flexible sheeting panel 20 is then anchored and sealed to the exposed side of concrete slab 4 above GLE 2 using 4″ wide gel tape 18. Both vertical edges of flexible sheeting panel 20 will then be sealed to the adjacent semi-rigid panels (not shown) using 2″ wide thin tape 19 as part of the integrated house wrap system.

FIG. 7 also illustrates the method for sealing the vertical edge of a semi-rigid panel 15a when it must initiate or terminate midway along an exterior wall 5a where there is no vertically-oriented wood trim available to accommodate an effective waterproof seal using 4″ wide gel tape 18. In this case, a solid or ribbed ˜¾″ wide by ½″ thick closed-cell foam gasket seal 15d will be pre-attached on the underside of a semi-rigid panel 15a along its vertically-oriented termination or initiation edge during pre-flood prep. Then, during emergency deployment, at least three 3/16″ diameter Tapcon® screws or other suitable screw fasteners 17 along with a ˜¾″ wide×⅛″ thick×24″ long panel edge stiffener 15c made of solid PVC or other rigid plastic material which has been placed at the edge and on the outside of semi-rigid panel 15a directly above where the foam gasket 15d was previously installed to secure and seal the edge of semi-rigid panel 15a to exterior wall 5a. A strip of 4″ wide gel tape 18 may then be used to cover and seal the panel edge stiffener 15c and screw fasteners 17 while optionally extending the 4″ wide gel tape 18 to cover and seal at least 2″ of the surface of exterior wall 5a from near GLE 2 to the DFE 3 (not shown).

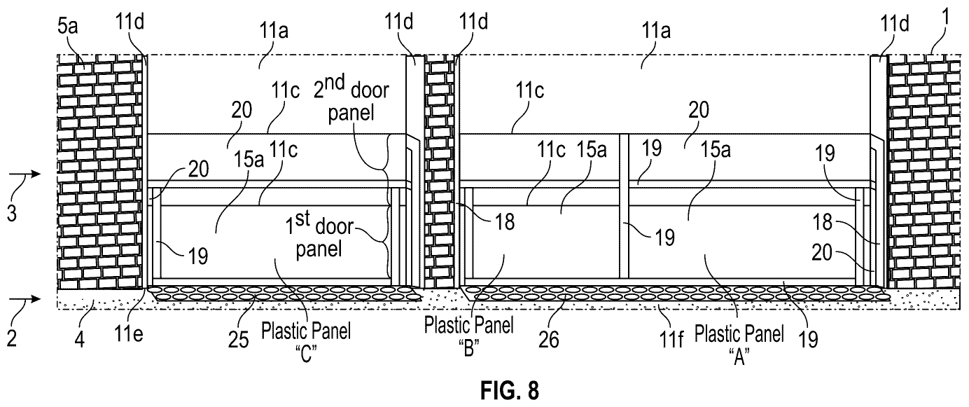

Referring now to FIG. 8, an elevational view illustrates sectional type garage doors 11a adjacent to masonry veneer walls 5a with articulated horizontal door panels 11c may also be protected to a height at or above the DFE 3 using the integrated house wrap system. During emergency deployment, the left vertical edge of the standard-length semi-rigid panel “A” 15a together with its pre-installed flexible sheeting panel 20 may be joined with the right vertical edge of the custom-sized semi-rigid panel “B” 15a along with its pre-installed flexible sheeting panel 20 using 2″ wide thin tape 19. Then the right edge of joined semi-rigid panels “A” and “B” 15a will be positioned parallel to and just a few inches to the left of the frame 11d of the rightmost garage door 11a and their vertical elevation may be adjusted such that their lower edge is just above (˜2″) the bottom edge of the garage door 11e when it is in a closed position. The upper edge of the combined flexible sheeting panels 20 of semi-rigid panels “A” and “B” 15a is simply folded over a few times to form a narrow ridge (e.g., approximately 1″ wide) which is then tucked into the closest articulated joint of door panels 11c located above the DFE 3 prior to completely closing the garage door 11a. Upon fully closing garage door 11a, the upper end of combined sheeting panels 20 will be fully secured at a height slightly above the DFE 3.

After securing the upper end of the house wrap covering the rightmost sectional type garage door 11a, the left and right vertically-oriented side edges of flexible sheeting panels 20 which were pre-attached to semi-rigid panels “A” and “B” 15a using 2″ wide thin tape 19 during pre-flood prep will be anchored and sealed to the left and right frames 11d, respectively of the rightmost garage door 11a using 4″ wide gel tape 19 in a manner similar to the process described for deployment of house wrap materials near the initiation and terminations points in FIG. 3. The lower edge of semi-rigid panels “A” and “B” 15a will be sealed at the driveway substrate 11f by applying flexible weighting material 25 (e.g., water-activated sandless weight bags) on top of the weight bag mats 26 that were pre-installed on the bottom of semi-rigid panels “A” and “B” 15a during pre-flood prep. Alternatively, the bottom edge of semi-rigid panels “A” and “B” 15a may be sealed to a concrete or tile driveway substrate 11f using a flexible sheeting panel 20 and 4″ wide gel tape 18 which were pre-attached to the bottom of semi-rigid panels “A” and “B” 15a during pre-flood prep. The general process for protecting the rightmost sectional type garage door 11a may then be repeated for additional garage doors 11a.

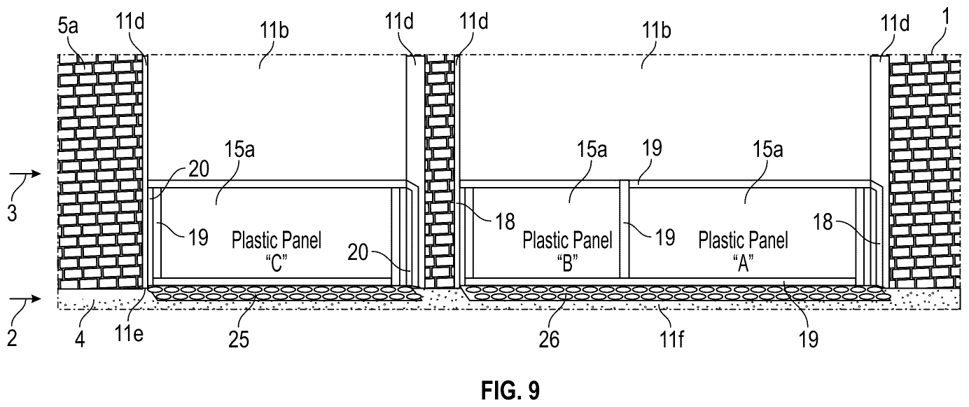

Referring now to FIG. 9, an elevational view illustrates non-sectional type garage doors 11b adjacent to masonry veneer walls 5a may also be protected to approximately the height of the DFE 3 using the integrated house wrap system. The same process described for FIG. 8 may be used for non-sectional garage doors 11b except for the method to anchor and seal the top edge of semi-rigid panels “A” and “B” 15a. For non-sectional garage doors, flexible sheeting panels 20 will not be attached to the top of semi-rigid panels “A” and “B” 15a as their upper edges will be directly anchored and sealed to garage door 11b at approximately the DFE 3 using 2″ wide thin tape 19. Also, semi-rigid panel “A” and “B” 15a may be deployed on non-sectional type garage doors 11b sequentially before sealing the left edge of semi-rigid panel “A” 15a with the right edge of semi-rigid panel “B” 15a using 2″ wide thin tape 19.

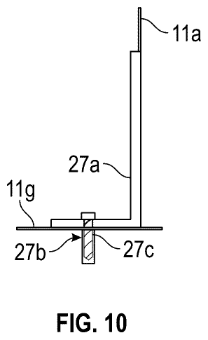

FIG. 10 illustrates an elevation view of how garage door support struts 27a may be pre-configured to facilitate emergency deployment on the inside of garage doors for reinforcement to ensure the garage doors 11a can handle the hydrodynamic forces imparted by encroaching flood waters. Support struts 27a are L-brackets with an approximately 1″ long horizontal member having a 5/16″ mounting hole for anchoring to the garage floor substrate 11g and an approximately 24″ tall vertical member, which will be aligned with the inside of garage door 11a. Each support strut 27a is pre-configured during pre-flood prep by pre-setting a ¼″ threaded masonry anchors 27b into garage floor substrate 11g for use with hex bolt fasteners 27c. Support struts 27a may be deployed approximately every 4′ along the inside of the garage door 11a during emergency deployment immediately preceding the flood event using ¼″ bolt fasteners 27c to maintain the support struts 27a in the proper position along in garage floor substrate 11g.

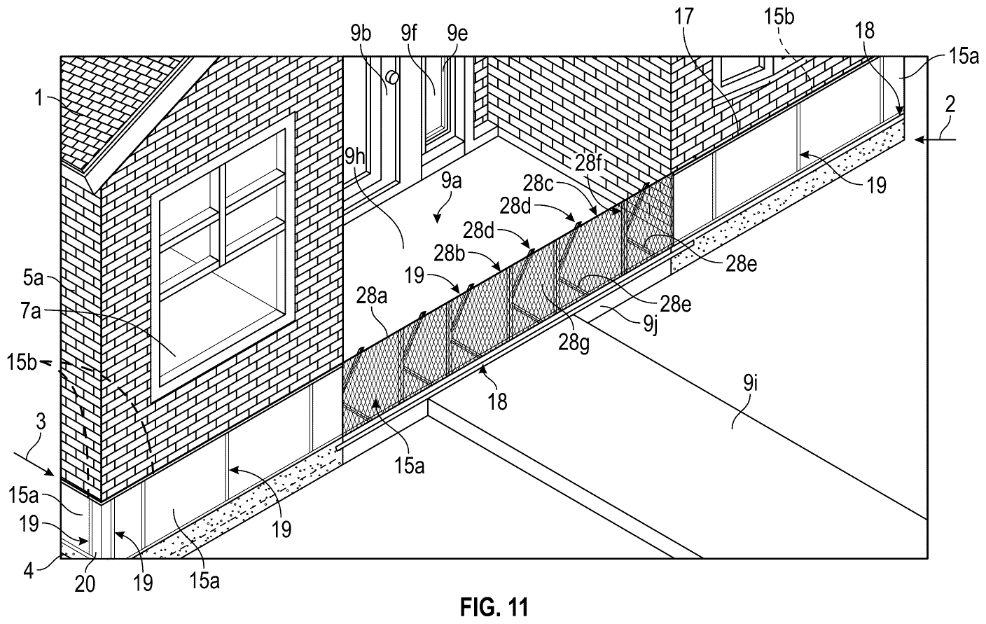

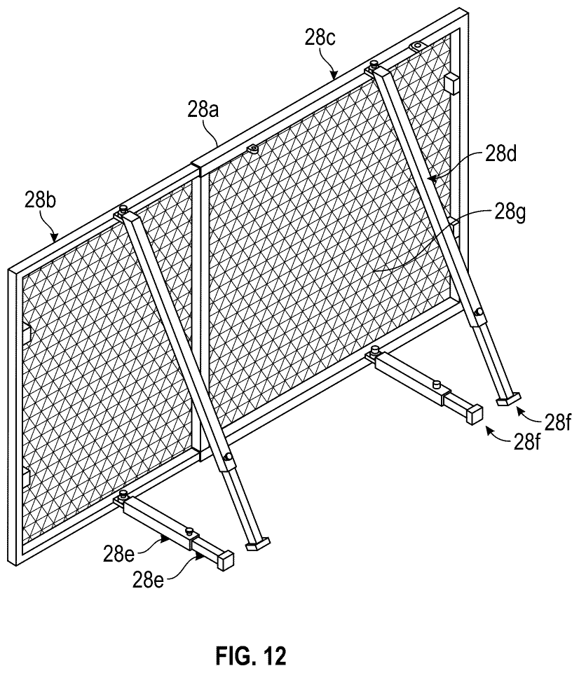

Referring now to FIGS. 11-12, perspective views illustrate entryway protectors 28a may also be used with this house wrap system method to protect relatively fragile front entryway pedestrian doors 9b and glass 9f of windows 9e at recessed exterior entryways 9a and are available in multiple pre-defined widths. Each pre-fitted protector assembly 28a includes an approximately ¾″ aluminum, PVC, or other hard plastic square tube male frame 28b, which telescopes into an approximately 1″ female square tube frame 28c to expand and contract to fit the width requirement of the entryway 9a.

The bottom of the frames 28c, 28b are supported using either (a) pre-existing ledge or step 9j at the entryway 9a to prevent bottom of frames 28c, 28b from sliding toward to the building structure 1, (b) telescopic aluminum struts 28d, 28e spaced horizontally every approximately 3 to 6 feet along the front porch substrate 9h and being supported near GLE 2 against both the protector frame 28c, 28b and the nearest available ledge 9j, wall 5a, or exterior door 9b of the building structure 1, or (c) anchoring the bottom of the protector assembly 28a to a concrete or tile substrate 9h, 9i using hex bolts with pre-installed threaded anchors 28f, which are permanently set into the substrate 9h, 9i. Screw-in covers (not shown) may be used to camouflage the threaded anchors prior to deployment.

The top of the frames 28c, 28b are supported using either (a) telescopic aluminum struts 28d pinned to the top of the frames 28c, 28b and which extend to the bottom of the adjacent structural wall 5a or exterior door 9b or alternatively using pre-set threaded masonry anchors in the entryway substrate and ¼″ hex bolts 28f to prop the frames 28c, 28b up when loaded against the rising flood waters, (b) cementing an approximately 1½″ square tube by 18″ long aluminum stanchion receiver post (not shown) into the ground or flooring substrate 9i during pre-flood prep such that the top of the receiver post is level with GLE 2 to facilitate installation of an L-shaped brace (not shown) made of 1¼″ square tube aluminum by inserting the lower end of the brace into the receiver and bolting the body to the brace immediately preceding the flood event. A protective cover (not shown) may be used to protect and camouflage the stanchion receiver prior to deployment.

Exterior walls 5a on both sides of the entryway 9a provide vertical support to the protector assembly 28a. Rigid plastic lattice panels 28g provide structural integrity while semi-rigid plastic panels 15a provide a waterproof barrier for entryway protectors 28a so the house wrap system can withstand the hydrodynamic forces of the encroaching flood waters at recessed fragile door and window entryway areas 9a.

Semi-rigid panels 15a are sealed horizontally at the bottom against transition step 9j using 4″ wide gel tape 18. Alternatively, the bottom edge of these semi-rigid panels 15a adjacent to entryway protectors 28a may be sealed using flexible weighting material placed onto weight bag mats which were pre-installed on the bottom edge of the semi-rigid panels 15a during pre-flood prep (not shown). The top of the semi-rigid panels 15a are secured to the top of protector assembly 28a using 2″ wide thin tape 19 applied to the top or outside surface of square frames 28c, 28b. Alternatively, 4″ wide gel tape 18 may be used to anchor the semi-rigid panels 15a to the top of protector assembly 28a (not shown). 2″ wide thin tape 19 is also used to join and seal multiple standard length (e.g., 8′ long) and shortened semi-rigid panels 15a covering and adjacent to the entryway protector 28a. The process for using the combination of semi-rigid panels 15a, closed-cell foam gaskets 15b, Tapcon® screw fasteners 17, 2″ wide thin tape 19, flexible sheeting panels 20, and 4″ wide gel tape 18 to protect exterior walls 5a of building 1 is described in FIG. 4. Note that a roof overhang of building 1 is required to protect the exterior entryway area 9a against wind-driven rain.

After the house wrap system has been deployed and the flooding threat has passed, the following process may be used to restore the home to its pre-flood condition:
Expandable door protector will be removed from the door designated for ingress/egress during the flood event.
Removable all-weather thin tape (˜2″ wide) and removable all-weather gel tape (˜ 4″ wide) will then be removed by using finger pressure to slowly and carefully pull the tape off the exterior building surface and semi-rigid plastic panels without leaving any glue residue on the surface. A pair of wide nose pliers may also be used. Pre-treatment of the application surface during pre-flood preparation with a suitable transparent chemical sealant will facilitate removal of the tape products. In the unlikely event a tape product is not being released from the surface with moderate tensile force, a solvent-based chemical adhesive removal product may be used as contingency to release the adhesive bond. For safety, nitrile gloves should be used when using chemical adhesive removal products. All removed tape products with any attached flexible sheeting panels will be discarded. These products will be replaced in preparation for a possible future deployment ahead of an impending flooding event.
Any sandless weight bags or other flexible weighting material will then be removed and either discarded or stored for a future possible deployment of the house wrap system. Discarded sandless weight bags should be replaced and stored along with other deployable solution components.
Tapcon® and/or other screw fasteners will then be removed using a cordless drill/driver and ¼″ hex bit to release the semi-rigid panels at their upper end. Screws, panel edge stiffeners, and semi-rigid panels will be retained for future use. Screw holes will then be patched using color/texture matched grout caulk or other suitable caulk material/color-matched paint.
Garage door support struts and entryway protectors will be removed via ¼″ bolts or screws and retained.
The house exterior will be inspected and any damaged surfaces will be repainted, re-stained/sealed, and/or otherwise repaired.
New flexible sheeting panels, 2″ wide thin tape, and 4″ wide gel tape will be cut-to-fit based on an inventory of deployable house wrap system components that was created during pre-flood prep. New 4″ wide gel tape will be pre-applied to certain house wrap system components as previously described for pre-flood prep scope of work.
All deployable solution components for the house wrap system will be packed away in a DIY deployment storage bag.

While the present disclosure has been described in connection with presently preferred embodiments, it will be understood by those skilled in the art that it is not intended to limit the disclosure to those embodiments. It is therefore contemplated that various alternative embodiments and modifications may be made to the disclosed embodiments without departing from the spirit and scope of the disclosure defined by the appended claims and equivalents thereof.

1. A method for protecting a home or building with a slab-on-grade foundation from flood waters, which comprises:
determining a size and number of waterproof, plastic panel(s) needed to protect an exterior area of the home or building from flooding between the foundation and a predetermined design flood elevation (DFE);
positioning each plastic panel, one at a time, against a respective section of the exterior area to be protected;
securing an upper edge of each plastic panel, one at a time, to an exterior surface of the home or building to form a top end horizontal water-resistant barrier;
securing a lower edge of each plastic panel, one at a time, to the foundation with a removable adhesive to form a bottom end horizontal waterproof seal; and
securing each vertical side edge of each plastic panel, one at a time, to at least one of an exterior surface of the home or building, and a vertical side edge of an adjacent plastic panel with the removable adhesive to form a waterproof seal between each plastic panel and at least one of an exterior wall, a door, and a window.

2. The method of claim 1, where in the upper edge of each plastic panel is secured to the exterior surface of the home or building with one of a plurality of mechanical fasteners and the removable adhesive.

3. The method of claim 2, wherein the plurality of the mechanical fasteners is selected from a group consisting of masonry screws, wood screws, and stainless steel brads with spring clips.

4. The method of claim 1, wherein the removable adhesive is a curable caulk or paste.

5. The method of claim 1, wherein the removable adhesive is a waterproof tape that adheres to smooth surfaces in wet or dry conditions.

6. The method of claim 5, wherein one side of the waterproof tape includes an adhesive film made with an acrylic resin.

7. The method of claim 1, wherein the removable adhesive is a waterproof tape that adheres to porous and non-porous surfaces in wet or dry conditions.

8. The method of claim 7, wherein one side of the waterproof tape includes an adhesive gel made with butyl rubber.

9. The method of claim 7, wherein the adhesive gel is protected by a removable liner during storage of the waterproof tape in cut-to-fit bulk rolls.

10. The method of claim 9, wherein the removable liner is divided into two sections separated along a length of the waterproof tape and each section is independently removable for application of the waterproof tape to different surfaces at different times.

11. The method of claim 1, wherein the removable adhesive is a double-sided tape that comprises:
an adhesive film on one side for adhesion to smooth surfaces in wet or dry conditions; and
an adhesive gel on another side for adhesion to porous and non-porous surfaces in wet or dry conditions.

12. The method of claim 11, wherein the adhesive gel is protected by a removable liner during storage of the waterproof tape in cut-to-fit bulk rolls.

13. The method of claim 11, wherein the adhesive gel includes an integral scrim fabric or imbedded fibrous material that facilitates its removal.

14. The method of claim 1, wherein a first plastic panel is positioned adjacent a bottom section of a vertically-oriented door frame on one side of the door and a last plastic panel is positioned adjacent a bottom section of the door frame on another side of the door.

15. The method of claim 1, wherein each plastic panel is adaptable to fit protuberances from the exterior area to be protected.

16. The method of claim 1, further comprising:
using waterproof flexible sheeting to extend plastic panel(s) along at least one vertical edge to transition adjacent plastic panels around a corner of the exterior wall or to provide flexible waterproof material between an adjacent plastic panel and a bottom section of a door frame;
securing the common vertical side edges of the plastic panel(s) and the flexible sheeting with removable adhesive; and
securing the other edges of the flexible sheeting against a respective section of the exterior area to be protected.

17. The method of claim 2, further comprising positioning a closed-cell foam gasket between the upper edge of each plastic panel and the exterior surface of the home or building.

18. The method of claim 15, further comprising attaching an exhaust vent extension assembly over a cutout in a plastic panel to protect an exhaust vent protruding from the exterior area to be protected from flooding while maintaining an air exhaust vent at or above the DFE.

19. The method of claim 1, further comprising pre-treating the exterior surface of the home or building from a ground level to the DFE with a transparent chemical sealant that facilitates removal of the removable adhesive.

20. The method of claim 19, further comprising removing each plastic panel from the exterior surface of the home or building with at least one of rotational force, tensile force, heat, a cooling stream, and a high pressure water force.

21. The method of claim 1, further comprising installing a door protector adjacent the exterior side of an exterior door to protect the door area from flood waters up to at least the DFE.
